(19) United States
(12) Patent Application Publication
(10) Pub. No.: US 2024/0208356 A1
(43) Pub. Date: Jun. 27, 2024

(54) TELSMART ELECTRIC VEHICLE CHARGING WITH 5G SMALL CELL/WIRELESS, DIGITAL OUT OF HOME ADVERTISING, COMBINED IN MULTI TECHNOLOGY NETWORK INFRASTRUCTURE

(71) Applicant: AIVEN GROUP, LLC., Myrtle Beach, SC (US)

(72) Inventor: Kevin Flannery, Myrtle Beach, SC (US)

(21) Appl. No.: 18/564,945

(22) PCT Filed: May 20, 2022
(86) PCT No.: PCT/US22/30182

§ 371 Date: Nov. 28, 2023

Related U.S. Application Data
(60) Provisional application No. 63/190,907, filed on May 20, 2021.

(51) Int. Cl. B60L 53/66; B60L 53/67; B60L 53/68; G06Q 30/0251

(52) U.S. Cl. CPC B60L 53/66; B60L 53/67; B60L 53/68; G06Q 30/0267

(57) ABSTRACT

A system for communication with an electric vehicle charging station. The system includes an electric vehicle charging station for charging an electric vehicle, a network operations center providing wired or wireless communication to at least the electric vehicle charging station, a fiber hub located on the site and connecting a high-speed (5G or greater) fiber-in line, from off-site, to at least one fiber-distribution line exiting the fiber hub. The system comprises a small cell high speed wireless transceiver (for transmitting and receiving wireless signals) connected to the fiber hub through the at least one fiber-distribution line. The network operations center is configured to send information to one or more persons in proximity to the transceiver including at least a driver of the electric vehicle and others inside or outside the electric vehicle.

### CROSS-REFERENCE TO RELATED APPLICATION

This application claims the benefit of U.S. Provisional Application No. 63/190,907, filed on May 20, 2021, the entire contents of each are incorporated herein by reference.

### BACKGROUND OF THE INVENTION

### Field of the Invention

The present invention is related to communications at an electric vehicle charging site.

### Description of the Related Art

The use of electric vehicles has recently increased and is expected to continue to grow in the near future. While electric vehicles may provide economic and/or environmental benefits, some drivers may have concerns regarding the use of alternative fuels. For example, the locations of charging stations, the distances that can be traveled without running out of power, and/or the appropriate maintenance schedules associated with electric vehicles may be unfamiliar to drivers. This may be especially true for drivers who are new to the electric vehicle experience. Similarly, businesses may be uncomfortable when introducing electric vehicles into an existing fleet of automobiles.

Proposed systems have provided information to electric vehicle drivers and/or owners regarding the use of electric vehicles as compared to traditional gasoline powered automobiles (e.g., an electric vehicle identifier might be transmitted to a charging station).

U.S. Pat. Appl. Publ. No. 2011/0238287 (the entire contents of which are incorporated herein by reference) describes vehicular charging facility guidance device which includes a route setting unit that sets a route from a departure point of a vehicle to a destination, a map display unit that displays a map on a display device, and a route display unit that displays the route set by the route setting unit to be overlapped with the map displayed on the display device.

U.S. Pat. No. 9,142,978 (the entire contents of which are incorporated herein by reference) describes a method of queue prioritization and an electric vehicle charging station. The method includes providing remote access to a queue for the electric vehicle charging station, the queue defining the order and duration of electric vehicles to be charged at the electric vehicle charging station, receiving a plurality of requests to utilize the electric vehicle charging station and entering those requests into the queue.

U.S. Pat. No. 9,300,152 (the entire contents of which are incorporated herein by reference) describes an electric vehicle charging station, an electric vehicle charging system, and methods of provisioning and operating an electric vehicle charging station. The electric vehicle charging station may include a power control to control the flow of power from a power grid, a controller coupled to the power controller, and a wireless communications interface operable to communicate using a short range wireless communications protocol.

U.S. Pat. No. 10,369,889 (the entire contents of which are incorporated herein by reference) describes systems, methods and devices in which electric vehicle information, including electric vehicle charging information, may be received over a communications network. In the '889 patent, the electric vehicle charging information may be automatically associated with automobile insurance premium information. An integrated presentation of the electric vehicle charging information and the automobile insurance premium information may then be transmitted, over the communications network, for presentation to an owner of the electric vehicle.

U.S. Pat. No. 10,391,876 (the entire contents of which are incorporated herein by reference) describes a method for operating a charging station, including establishing a communication link between the charging station and an electric vehicle; checking, via the communication link, whether a software stored on a processing unit of the electric vehicle has to be updated; and transmitting, as a function of the check, update data for updating the software via the communication link to the electric vehicle with the aid of the charging station so that the software may be updated based on the update data.

### SUMMARY OF THE INVENTION

In one embodiment, there is provided a system for communication at an electric vehicle charging site. The system comprises an electric vehicle charging station for charging an electric vehicle, a network operations center providing wired or wireless communication to at least the electric vehicle charging station, a fiber hub located on the site and connecting a high-speed (5G or greater) fiber-in line, from off-site, to at least one fiber-distribution line exiting the fiber hub. The system comprises a small cell high speed wireless transceiver (for transmitting and receiving wireless signals) connected to the fiber hub through the at least one fiber-distribution line, and a network operations center connected to the fiber hub through the at least one fiber-distribution line. The network operations center is configured to send information to one or more persons in proximity to the transceiver including at least a driver of the electric vehicle and others inside or outside the electric vehicle. The information from the network operations center and broadcast by the transceiver comprising a menu of at least electric vehicle data and advertising data.

In one embodiment, there is provided a method for communication at an electric vehicle charging station. The method communicates to at least the electric vehicle charging station via a communications network, stores historical data and informational data for communication; and delivers the historical data and informational data by wireless broadcast from a site of the electric vehicle charging station to at least a driver of the electric vehicle and other persons inside or outside an electric vehicle. The historical data includes one or more past electric charge dates, past times for charging, and amounts of electric charge suppled to the electric vehicle. The informational data is provided at least a driver of the electric vehicle and other persons inside or outside the electric vehicle, and the informational data includes at least electric vehicle data, advertising data, and entertainment data.

In one embodiment, there is provided a computer program product which when executed on a processor performs the functions of communicating to at least the electric vehicle charging station via a communications network, storing historical data and informational data for communication, and delivering the historical data and informational data by wireless broadcast from a site of the electric vehicle charging station to at least a driver of the electric vehicle and other persons inside or outside an electric vehicle. The historical data includes one or more past electric charge dates, past times for charging, and amounts of electric charge suppled to the electric vehicle. The informational data is provided at least a driver of the electric vehicle and other persons inside or outside the electric vehicle, and the informational data includes at least electric vehicle data, advertising data, and entertainment data.

It is to be understood that both the foregoing general description of the invention and the following detailed description are exemplary, but are not restrictive of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing, wherein:

FIG. 1 illustrates an electric vehicle (EV) charging system according to various embodiments of the invention.

FIG. 2 is a flowchart illustrating one method of the present invention for communication at an electric vehicle charging station.

FIG. 3 is an example of an EV charging platform according to various embodiments of the invention.

FIG. 4 is an illustrative example of a portion of a tabular database in accordance with various embodiments of the invention.

FIG. 5 is an example of an integrated EV charging display according to various embodiments of the invention.

FIG. 6 illustrates a system architecture according to various embodiments of the invention.

FIG. 7 illustrates an electric vehicle system architecture in accordance with various embodiments of the invention.

FIG. 8 is a block diagram depicting an electric vehicle information system in accordance with various embodiments of the invention.

FIG. 9 is a block diagram of a system in accordance with various embodiments of the invention.

### DETAILED DESCRIPTION OF THE INVENTION

The present invention is directed to packaging and delivery of services, solutions related to systems and methods and computer program products for charging electric vehicles, more specifically delivering 5G high speed (or higher) wireless Internet and digital out of home advertising in a combined menu of services, solutions system on site where electric vehicles are being charged.

Embodiments of the present invention relate to systems and methods associated with electric vehicle (EV) charging stations. While electric vehicles may provide economic and/or environmental benefits, some drivers may have concerns regarding the use of alternative fuels. For example, the locations of charging stations, the distances that can be traveled without running out of power, and/or the appropriate maintenance schedules associated with electric vehicles may be unfamiliar to drivers. While these concerns are not alleviated by the present invention, the present invention according to various embodiments provides drivers with an environment for charging an electric vehicle which permits the driver to access internet and be provided informational data making the time spent at the charging station more productive and conducive to a driver's interest and needs.

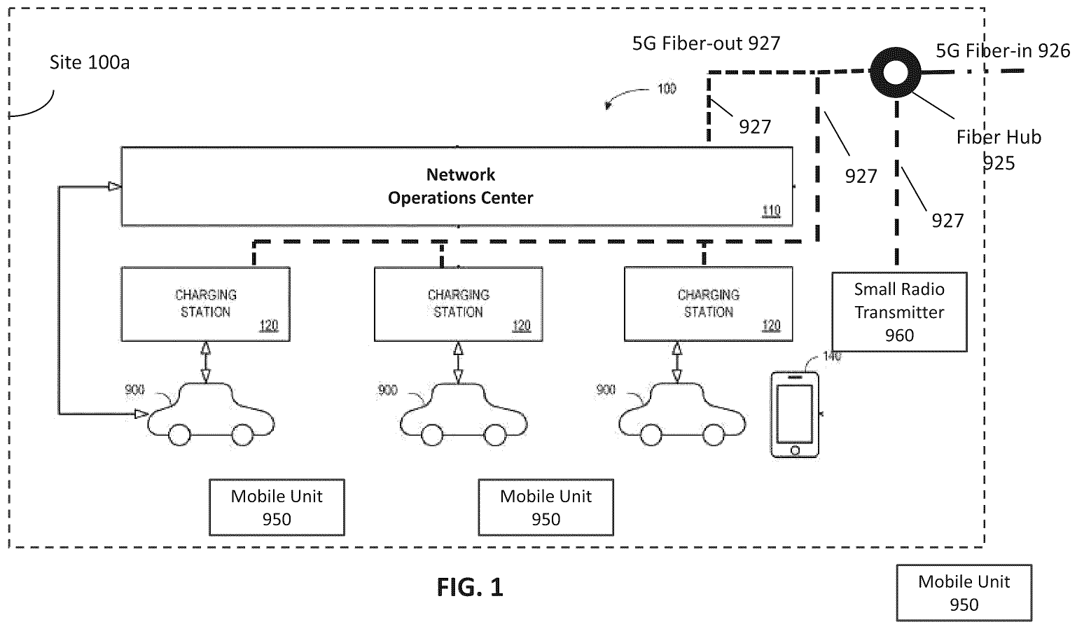

FIG. 1 illustrates an electric vehicle (EV) system 100 according to one embodiment of the present invention. As used herein, the phrase “electric vehicle” may refer to any vehicle that is at least partially powered by electricity, including a hybrid electric vehicle, a Plug-in Hybrid Electric Vehicle (“PHEV”), or a Battery Electric Vehicle (“BEV”). As shown in FIG. 1, network operations center 110 exchanges information with one or more “electric vehicles” 900 or with one or more mobile units 950 associated with the electric vehicles 900 by way of small radio transmitter 960, which can function as a receiver and referred to herein as transmitter 960 or transceiver 960. In one embodiment, the transceiver 960 is mounted on a security light pole at an electric vehicle charging site 100a or nearby site 100a. In one embodiment, the mobile units 950 may be on-board computers connected to an engine in the electric vehicle. In one embodiment, the mobile units 950 may be a driver's (or company's) laptop or personal computing device disposed insider or outside the electric vehicle 900 or nearly the electric vehicle 900 or otherwise in proximity to small radio transceiver 960. In one embodiment, the mobile units 950 may be with a driver who has left his/her electric vehicle and is inside a store or outside a store. In one embodiment, the mobile units 950 may be the laptop of another person (not the driver) and/or his/her personal computing device in communication with the small radio transceiver 960, and in one embodiment, in proximity to the small radio transceiver 960. As used herein, “in proximity” means to be close enough for wireless communication with the transceiver 960.

In one embodiment, transceiver 960 can exchange information directly with the electric vehicle 900 or directly with mobile units 950 (e.g., via a wireless communication network). In other embodiments, network operations center 110 and/or transceiver 960 may exchange information about the electric vehicle 900 via fiber lines 927. The information exchanged might include, for example, a driver or vehicle identifier, a location (e.g., of a charging station), a time of day and/or date, and/or maintenance information. The network operations center 110 may then use the information about the electric vehicle 900 and/or information from one or more databases 130 in accordance with any of the embodiments described herein. The information exchanged might also include, for example, advertisements for the driver or person associated with the mobile units 950. The information exchanged might also include, for example, information for the driver or person associated with the mobile units 950 regarding news, weather, sports, etc. The information exchanged might also include, for example, warranty information on the electric vehicle and suggested maintenance needed for the electric vehicle. The information exchanged might also include, for example, a destination of the driver and traffic reports along one or more routes to the destination. The information exchanged might also include, for example, expected power consumption for the roads the driver may take, and where other EV charging stations are along a route. The information exchanged might also include, for example, expected power consumption for the roads the driver may take (including power consumption on one or more roads to the destination. The information exchanged might also include, for example, where other EV charging stations are along a route that the driver may follow. The information exchanged might also include, for example, information about the history of the expenses paid out for the electric vehicle including for example the frequency of charging, the locations of charging, and past prices paid for charging. The information exchanged might also include, for example, information about the driver. For example, the driver may have already recorded important information about himself or herself such a medical or otherwise heath related condition. In one embodiment, an electric vehicle display, a charging station display, and/or a display on the mobile unit is programmed to show an emergency icon which, when activated, will display this kind of information such that others on the scene may be able to know better the condition of the driver or used of mobile unit 950. The information exchanged could also include marketing information, entertainment information, etc. In one embodiment, social network information may be automatically updated when a driver accesses a charging station. For example, a message might be posted on a FACEBOOK® social network service profile indicating that the driver has saved money or obtained a particular environmental benefit by charging his or her vehicle. As another example, a TWITTER® social network service account might be automatically updated to help other users of a shared community vehicle determine the current location of the vehicle.

Accordingly, in one embodiment, there is provided a system 100 for communication at an electric vehicle charging site 100a. The system 100 comprising an electric vehicle charging station 120 for charging electric vehicle 900; a network operations center 110 providing wired or wireless communication to at least the electric vehicle charging station 120; a fiber hub 925 located on the site 100a and connecting a high-speed (5G or greater) fiber-in line 926, from off-site, to at least one fiber-distribution line 927a exiting the fiber hub 925; and a small cell high speed wireless transceiver 960 connected to the fiber hub 925 through the at least one fiber-distribution line 927a (the transceiver 960 for transmitting and receiving wireless signals). The network operations center 110 is configured to send information to one or more persons in proximity to the transceiver 960 including at least a driver of the electric vehicle 900 and others inside or outside the electric vehicle. The information from the network operations center 110 and broadcast by the transceiver 960 comprising a menu of at least electric vehicle data and advertising data.

As shown in FIG. 1, there is a wireless transmitter 960 which broadcasts the information to a person proximate the electric vehicle charging station 120 including at least a driver of an electric vehicle and for delivery to other persons inside or outside the electric vehicle. In one embodiment of the present invention, the charging stations 120 have fiber 927 extending from fiber hub 925 for communication through another fiber 927 to the network operations center 110. In one embodiment of the present invention, fiber hub 925 is connected to the outside world via a 5G Fiber-in 926. In one embodiment, the on-site components shown in FIG. 1 can operate at 5G or higher depending on the carrier's service to the site. While transceiver 960 is shown in FIG. 1 inside the site 100a, the transceiver 960 could be outside the site 100a.

In one embodiment of the present invention, digital out-of-home (DOOH) media will be supplied over the fiber-in 925 to components of system 100. Out-of-home (OOH) advertising is traditional (i.e., non-digital and non-programmatic) outdoor advertising. Also known as out-of-home media or outdoor media, OOH advertising is related messaging to consumers when they are in public places, commuting to work, waiting (e.g. in elevators), and in specific commercial locations. Typical OOH formats include billboards, on-car ads, bus-stop shelters, etc. Meanwhile, DOOH media is an advancement of OOH which includes techniques such as geofencing, tracking, retargeting, personalizing, attribution and measurement. In general, digital out-of-home media, or DOOH media, refers to digital media that appears in environments accessible to the public. This includes digital billboards and outdoor signage, as well as networks of screens found in businesses like malls, convenience stores, airports and healthcare providers (public/consumer venues). DOOH is a broad category, which can be deployed for all types of advertisement(s). In one embodiment of the present invention, DOOH advertising is broadcast from transceiver 960 to displays in vicinity of the transceiver 950 such as for example an electric vehicle display, a charging station display, a mobile unit display, and/or displays on personal devices such as mobile phones, laptops, and other personal computing devices within a vicinity of the transceiver 960. In one embodiment, the charging station displays, the mobile unit displays (cell phones, laptops, iPads, MacBook's, etc.) and similar displays on other personal computing devices can display an upgraded wireless service and other technology focused offerings within and across a network of systems 100.

In one embodiment of the present invention, small cell high speed wireless transceiver 960 may be a Wi-Fi broadcaster permitting not only customers of the charging stations 120 to access the Wi-Fi, but also others who stop on the site for other purposes including that of merely accessing the Wi-Fi.

In one embodiment of the present invention, by having 5G small cell high speed capability supported by the fiber-in 926, the fiber-based interconnectivity constitutes at least a 90% up time. In one embodiment of the present invention, these capabilities permit an uptime of at least 95%. In one embodiment of the present invention, these capabilities permit an uptime of at least 98%. In one embodiment of the present invention, these capabilities permit an uptime of at least 99%.

Additionally, these capabilities permit personal devices of the drivers of the electric vehicles 900 and users of the mobile units 950 to log-in and access the network, while for example the cars are being charged or other services on site are attended to. Furthermore, the displays on the charging stations and the mobile units and on the personal devices can all show the DOOH media (or other disruptive media).

In one embodiment, a user interface may be provided on the displays noted above, which may be on devices such as for example a mobile telephone, PDA, personal computer, or the like. For example, mobile devices may be an IPHONE® telephone from Apple, Inc., a BLACKBERRY® telephone from RIM, a mobile phone using the Google ANDROID® operating system, or the like. The user interface can depict a portion of a map. The user interface may display the location of charging stations 120 to a driver of the electric vehicle 900.

According to various embodiments, the network operations center 110 may be associated and/or communicate with a Personal Computer (PC), an enterprise server, or a database farm. As used herein, devices (including those associated with network operations center 110, and any other device described herein) may exchange information via any communication network, including one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

A number of processes can be performed by system 100. Note that any of the methods or processes described herein may be performed by hardware, software, or any combination thereof. For example, a computer-readable storage medium may store thereon instructions that when executed by a machine result in performance according to any of the embodiments described herein.

As noted above, a variety of information is distributed to charging stations 120, electric vehicles 900 (and thereby to the drivers of the electric vehicles 900), mobile units 950 (and thereby to persons with the mobile units 950), and others in proximate the network operations center 110 or the charging stations 120 or the transceiver 960 The information distribution may flow from the network operations center 110 via fiber hub 925 to one or more of the charging stations 120, the electric vehicles 900, the mobile units 950, and those in proximity to the transceiver 960. Conversely, the information distribution may flow to the network operations center 110 from one or more of the charging stations 120, the electric vehicles 900, the mobile units 950, and those in proximity to transceiver 960. Such information may include electric vehicle information, including electric vehicle charging information, electric vehicle information, electric vehicle identification information, and/or a mobile payment device. The electric charging information may include a geographic location of the electric charging station 120, an amount of electric charge provided for the electric vehicle 120, a date and time, a driver identifier, an electric vehicle identifier, and/or a cost associated with an electric charge provided for the electric vehicle.

In one embodiment, an integrated presentation of the information (including for example the electric vehicle charging information) may be transmitted for display to an owner of the electric vehicle 120. The contents of the display (optionally including program code activating the display) may be transmitted to and appear on a display of the electric charging station 120, a display of the electric vehicle 900, a display of the mobile unit 950, a display of a mobile payment device (such as a smart phone of the driver), or a display of on personal devices of others in vicinity of transmitter 960 including, but not limited to, a merchant inside the store hosting the charging stations 120. The information may also be sent to communication address associated with an owner of the electric vehicle (e.g., a home address or email address).

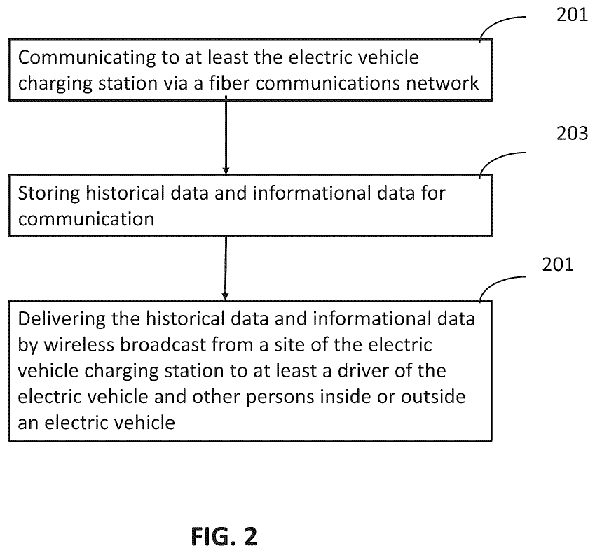

FIG. 2 is a flowchart illustrating one method of the present invention for communication at an electric vehicle charging station. At 201, this method communicates to at least the electric vehicle charging station via a fiber communications network. At 203, this method stores historical data and informational data for communication. At 205, this method delivering the historical data and informational data by wireless broadcast from a site of the electric vehicle charging station to at least a driver of the electric vehicle and other persons inside or outside an electric vehicle. The historical data includes one or more of past electric charge dates, past times for charging, and amounts of electric charge suppled to the electric vehicle. The informational data is provided at least a driver of the electric vehicle and other persons inside or outside the electric vehicle, and the informational data includes a menu of at least two or more of electric vehicle data, advertising data, and entertainment data. In one embodiment of the present invention, this method is embodied in a non-transitory computer-readable storage medium.

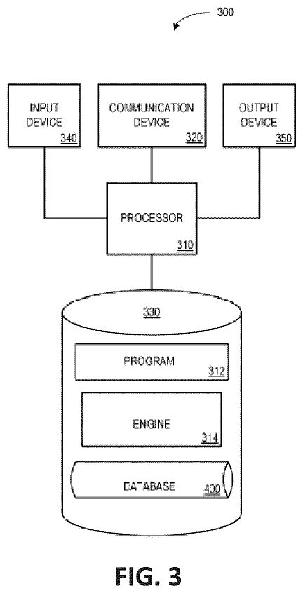

FIG. 3 depicts one example of network operations center 300 suitable for use in the present invention. The network operations center 300 may be, for example, associated with the system 100 of FIG. 1. The network operations center 300 comprises a processor 310, such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more remote charging stations, electric vehicles, or mobile payment devices. The network operations center 300 further includes an input device 340 (e.g., a mouse and/or keyboard to enter driver or electric vehicle information) and an output device 350 (e.g., a computer monitor to display aggregated electric vehicle reports and/or results to an administrator).

The processor 310 also communicates with a storage device 330. The storage device 330 may comprise any appropriate information storage device, including combinations of magnetic storage devices (e.g., a hard disk drive), optical storage devices, and/or semiconductor memory devices. The storage device 330 stores a program 312 and/or an engine 314 for controlling the processor 310. The processor 310 performs instructions of the programs 312, 314, and thereby operates in accordance with any of the embodiments described herein. For example, the processor 310 may receive electric vehicle information, including electric vehicle charging information. The processor 310 may transmit, over a communications network, an integrated presentation of the electric vehicle charging information (as described above) for presentation to a driver of the electric vehicle.

In FIG. 3, the programs 312, 314 may be stored in a compressed, uncompiled and/or encrypted format. The programs 312, 314 may furthermore include other program elements, such as an operating system, a database management system, and/or device drivers used by the processor 310 to interface with peripheral devices. As used herein, information may be “received” by or “transmitted” to, for example: (i) the network operations center 300 from another device; or (ii) a software application or module within the network operations center 300 from another software application, module, or any other source.

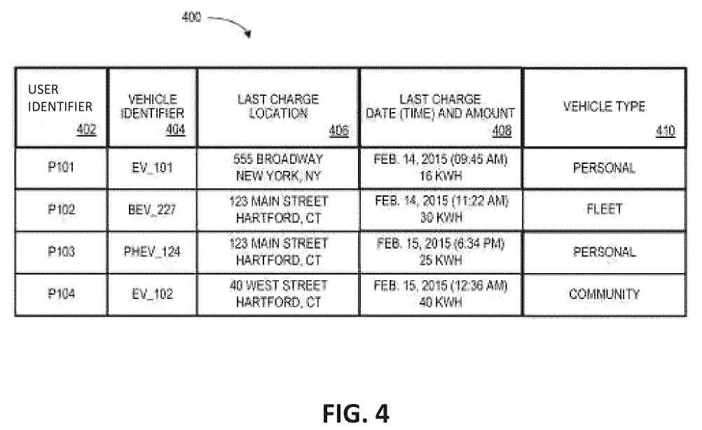

In various embodiments, storage device 330 stores a database 400. An example of a database that may be used in connection with the EV charging platform 300 will be described in detail with respect to FIG. 4. Note that the database described herein is only one example, and additional and/or different information may be stored therein. Moreover, various databases might be split or combined in accordance with any of the embodiments described herein.

Referring to FIG. 4, an exemplary table is shown that represents database 400 that may be stored at the network operations center 300. The table may include, for example, entries identifying products that may be offered in connection with electric vehicles. The table may also define fields 402, 404, 406, 408, 410 for each of the entries. The fields 402, 404, 406, 408, 410 may, according to various embodiments, specify: a user identifier 402, a vehicle 404, a last charge location 406, a last charge date/time and amount 408, and a vehicle type 410. The information in database 400 may be created and updated, for example, whenever data is received from the charging stations.

The user identifier 402 may be, for example, a unique alphanumeric code identifying a driver regardless of the particular electric vehicle that the driver may bring to the charging station 120. The vehicle identifier 404 may be, for example, associated with a particular electric vehicle and may, for example, corresponding to an identifier received from a charging station or payment device. The last charge location 406 might, for example, be an address or other geographic code indicating where the electric vehicle received a charge. Although a single charge is illustrated in FIG. 4 in the entries in the table, in actually a log of charges would likely be maintained in the database 400. The last charge date/time and amount 408 may indicate when the charge was provided to the electric vehicle along with the cost of the charge.

The vehicle type 410 may indicate, for example a personal vehicle, a fleet of electric vehicles, or a shared neighborhood or community vehicle.

In the case of payment for electric services, a driver might swipe a single card to charge an electric vehicle at home and at public stations, where the card is pre-authorized for paying for the electric charge. The card may have the option to be pre-loaded so that drivers can pay-by-the-charge. For drivers that use such a pre-pay option, additional benefits may be available (e.g., for free “fill ups”) based on driving habits, loyalty, etc.

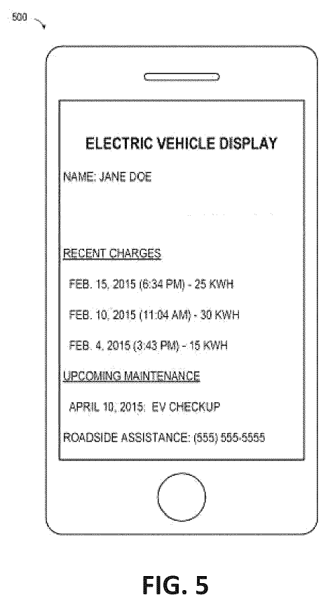

In one embodiment, a driver might use his/her mobile phone application to reserve a spot at a particular charging station and/or at a particular date and time. In another embodiment, if a driver is stranded due to charge depletion in their electric vehicle, he or she might call a pre-approved roadside assistance number provided on the back of the payment card, or provided and available for display on the integrated display 500 of FIG. 5. The phone number might coordinate a service truck to either complete a quick charge of the vehicle or tow the vehicle home to charge at a convenient location. The card or the integrated display 500 may also provide drivers with access to other electric vehicles drivers through an online community as well as electric vehicle experts at pre-certified maintenance shops.

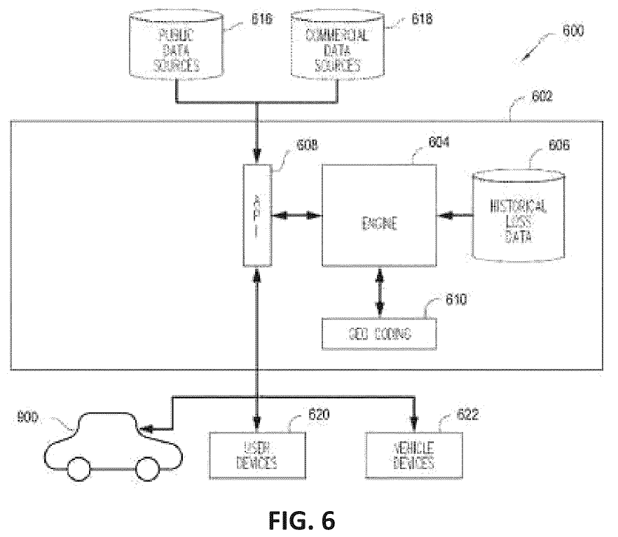

Referring to FIG. 6, FIG. 6 depicts an exemplary network 600 for providing EV charging information. As depicted, network 600 includes a number of devices which together operate to generate, store and utilize the information being transferred between the network operations center 110, the one or more of the charging stations 120, the electric vehicles 900, the mobile units 950, and those in proximity to transceiver 960.

Network 600 includes a processing system 602 with an engine 604 that generates the information that may be provided to a number of drivers, such as the drivers operating electric vehicles 900, other user devices 620 (such as personal computers, mobile phones, or the like), and vehicle devices 622 (such as charging stations, navigation systems or the like). Data may be provided from electric vehicles 900, user devices 620 and vehicle devices 622 (e.g., including charging stations) to update any data such as electricity consumption. In various embodiments, address and location data may expressed (or “geocoded”) as a location (or “geocode”) given in latitude and longitude, using standard decimal degrees notation for the latitudes and longitudes, although other spatial and locational data may also be used to code and tag data associated with the present invention.

In various embodiments, the geocoding or tagging may include identifying specific types of locations, such as electric vehicle charging stations, or the like, and other information associated with those locations. In various embodiments, system 602 includes a geocoding engine 610 which operates on received data to express the data as a location. For example, the geocoding engine 610 may be used on address data received, and translate or express the address as a latitude and longitude. The engine 610 may also append other location-related data to the address data to provide additional location information to the data. The “geocoded” data may then be stored, used as an input to engine 604, or presented to a user device (e.g., such as an electric vehicle 900, etc.) for use (e.g., such as by presenting the data in a map format or overlay).

In some embodiments, the historical loss data 606 and other input data sources 616, 618 are selected based on variables that have a high correlation to loss. In various embodiments, the following types of data may be used as inputs to engine 604: (i) data from historical loss data 606 including historical data associated with electric vehicle charging, (ii) data from public data sources 616, including census and demographic data (e.g., such as population density, crime statistics, emergency call data, highway and road construction data), and (iii) data from commercial data sources 618 (such as LOJACK® anti-theft system or ONSTAR® vehicle information system, and EZ-PASS® highway toll payment system or the like). This data may further be enhanced or updated using data from users operating electric vehicles 900, other user devices 620 and vehicle devices 622 (e.g., such as electric vehicle charging stations).

In various embodiments, an application program interface (API) 608 may include one or more APIs that expose some or all of the data to external services. For example, in one embodiment, an API may be provided that allows the data to be merged or integrated with data from external mapping services, such as GOOGLE® Maps mapping service, or MAPQUEST® mapping service. In such embodiments, users viewing a map displayed on an electric vehicle 900, other user device 620 or vehicle device 622 may select to view an overlay or integrated display of the information data. Examples of such a view are provided to help a user view, plan, and create routes appropriate for an electric vehicle.

In various embodiments, data may be transmitted between devices using a wireless network. In some embodiments, or all, of the data may be transmitted using other network communication techniques (e.g., such as satellite communication, RFID, or the like). In various embodiments, some or all of the data transmitted between devices may be encrypted or otherwise secured to prevent intrusion.

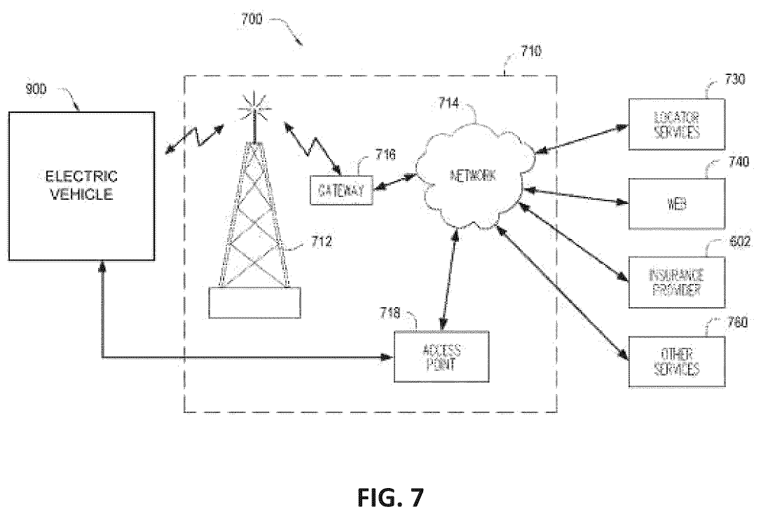

Reference is now made to FIG. 7 which is a block diagram of an example network environment 700 showing communication paths between an electric vehicle 900 (such as for example the electric vehicle 900 of FIG. 1) and other devices and data sources. The electric vehicle 900 (in addition to being capable of communicating with transmitter/receiver 960) may be, for example, any type of hybrid and/or battery operated automobile. The electric vehicle 900 of FIG. 6 can, for example, communicate over one or more wired and/or wireless networks 710. As an example, a wireless network can be a cellular network (represented by a cell transmitter 712 off site from transmitter/receiver 960). Electric vehicle 900 may communicate over a cellular or other wireless network and through a gateway 716 may then communicate with a network 714 (e.g., such as the Internet or other public or private network). An access point, such as access point 718 may be provided to facilitate data and other communication access to network 714.

In various embodiments, electric vehicle 900 may engage in both voice and data communications over the wireless network 712 via access point 718 or over wireless communication to and from transceiver 960. For example, the electric vehicle 900 may be able to place or receive phone calls, send and receive emails, send and receive short message service (“SMS”) messages, send and receive email messages, access electric documents, send and receive streaming media, or the like, over the wireless network through the access point 718. Similar communications may be made via the network 712.

In various embodiments, an electric vehicle 900 may also establish communication by other means, such as, for example, wired connections with charging stations, networks, peer-to-peer communication with other devices (e.g., using Bluetooth networking or the like), etc.

The electric vehicle 900 can, for example, communicate with one or more services over the networks 710, such as service providers 730-260 and the processing systems 602 (described above in conjunction with FIG. 6). For example, a locator service 730 may provide navigation information, e.g., map information, location information, route information, and other information, to the electric vehicle 900.

Other services may include, for example, other web-based services 740 (e.g., such as data services or the like), media services (e.g., providing photo, video, music, or other content), and/or download services (e.g., allowing applications and software or the like to be downloaded, etc.).

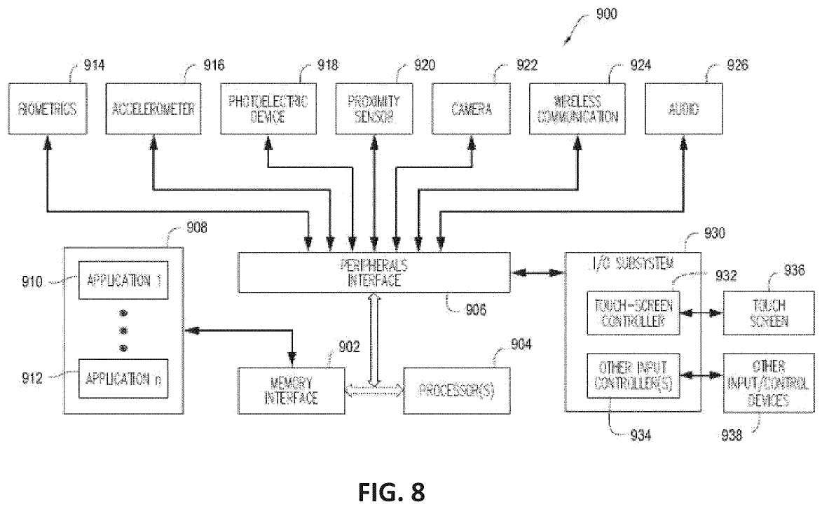

In FIG. 8, details of an electric vehicle 900 according to another embodiment are shown. As depicted, the electric vehicle 900 (such as for example the electric vehicle 900 of FIG. 1) includes a number of components which may be controlled or perform functions in conjunction with one more application programs 910-912 to perform the features of various embodiments. The electric vehicle 900 can include a memory interface 902 one or more data processors, image processors and/or central processing units 904, and a peripherals interface 906. The memory interface 902, the one or more processors 904 and/or the peripherals interface 906 can be separate components or can be integrated in one or more integrated circuits. The various components in the electric vehicle 900 can be coupled by one or more communication buses or signal lines.

Sensors, devices and subsystems can be coupled to the peripherals interface 906 to facilitate multiple functionalities. For example, a biometrics sensor 914, an accelerometer 916, a photoelectric device 918, a proximity sensor 920, a camera 922, a wireless communication unit 924, and an audio unit 926 may be provided to facilitate the collection, use and interaction with data and information and to achieve the functions of the applications described further below.

The electric vehicle 900 may include one or more input/output (I/O) devices and/or sensor devices. For example, input controllers 934 may be provided with a speaker and a microphone (not shown) to facilitate voice-enabled functionalities, such as phone and voice mail functions. In some implementations, a loud speaker can be included to facilitate hands-free voice functionalities, such as speaker phone functions. An audio jack can also be included for use of headphones and/or a microphone.

The I/O subsystem 930 can include a touch screen controller 932 and/or other input controller(s) 934. The touch-screen controller 932 can be coupled to a touch screen 936. The touch screen 936 and touch screen controller 932 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 936.

The other input controller(s) 934 can be coupled to other input/control devices 938, such as one or more buttons, rocker switches, thumb-wheel, infrared port, USB port, and/or a pointer device such as a stylus. The one or more buttons (not shown) can include an up/down button for volume control of the speaker and/or the microphone. In some implementations, a proximity sensor 920 can be included to facilitate the detection of the electric vehicle 900 proximate to an electric vehicle charging station.

Other sensors can also be used. For example, in some implementations, a photoelectric device 918 may be provided to facilitate adjusting the brightness of the touch-screen display 938. In some implementations, an accelerometer 916 can be utilized to detect movement of the electric vehicle 900. In some embodiments, the electric vehicle 900 may include circuitry and sensors for supporting a location determining capability, such as that provided by the global positioning system (GPS) or other positioning system (e.g., electric charging station systems using Wi-Fi access points, television signals, cellular grids, Uniform Resource Locators (URLs)). In some implementations, a positioning system (e.g., a GPS receiver) can be integrated into the electric vehicle 900 or provided as a separate device that can be coupled to the electric vehicle 900 through a peripherals interface 906 to provide access to location-based services. The positioning and location-based services may be used, for example, to tag data transmitted from the electric vehicle 900 to provider systems 102 (either directly or though a charging station or mobile payment device or provider). The electric vehicle 900 can also include a camera lens and sensor 922.

The electric vehicle 900 can also include one or more wireless communication subsystems 924, such as an 802.11b/g communication device, and/or a BLUETOOTH® Bluetooth® communication device to exchange information with an electric charging station. Other communication protocols can also be supported, including other 802.x communication protocols (e.g., WiMax, Wi-Fi), code division multiple access (CDMA), global system for mobile communications (GSM), Enhanced Data GSM Environment (EDGE), 3G (e.g., EV-DO, UMTS, HSDPA), etc. In some implementations, additional sensors or subsystems may be coupled to the peripherals interface 906 via connectors such as, for example a Universal Serial Bus (USB) port, or a docking port, or some other wired port connection.

The memory interface 902 can be coupled to memory 908. The memory 908 can include high-speed random access memory and/or non-volatile memory, such as one or more magnetic disk storage devices, one or more optical storage devices, and/or flash memory (e.g., NAND, NOR). The memory 908 can store an operating system, such as DARWIN operating system, RTXC operating system, LINUX operating system, UNIX operating system, OS X operating system, WINDOWS operating system, or an embedded operating system such as VXWORKS operating system. The operating system may include instructions for handling basic system services and for performing hardware dependent tasks. In some implementations, the operating system can be a kernel (e.g., UNIX kernel).

The memory 908 can also store data, including but not limited to documents, images, video files, audio files, and other data. In some implementations, the memory 908 stores a vehicle identifier and address book data, which can include contact information (e.g., address, phone number, etc.) for one or more persons, organizations, services, or entities.

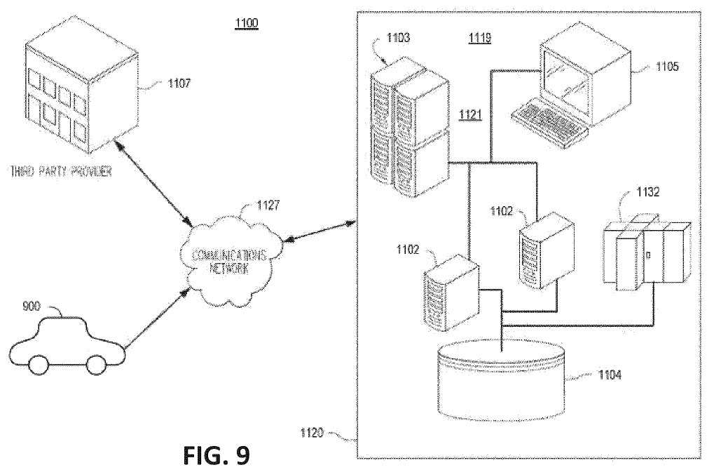

FIG. 9 is a schematic diagram of a system 1100 for monitoring, evaluating, and providing information to an electric vehicle 900 or the mobile unit 950 or to those in vicinity of transceiver 960. An EV information service provider 1120 can simultaneously provide the information to multiple drivers, although only one electric vehicle 900 is shown in FIG. 9. In one embodiment, EV information service provider 1120 functions as the network operations center 110 of FIG. 1, but is located across an internet connection to fiber hub 925.

In various embodiments, the electric vehicle 900 itself may execute an application and provide information to a drive (e.g., via a dashboard display of integrated information). A mobile device may store an application program that may be loaded onto the mobile device from the EV information service provider company 1120 or from an application repository (e.g., such as Apple's App Store or the like). In still other embodiments, a terminal or screen at a charging station may execute similar applications.

A variety of different types of data and information may be provided from application to the EV information service provider company 1120, including static data regarding the driver such as the driver's user name, password, policy information, etc. The data from mobile device 1130 may be transmitted via communications network 1127 to the EV information service provider company 1120 for evaluation and processing. A third party provider 1107 can also be a source of information associated with drivers and the electric vehicles.

The EV information service provider company 1120 has a computer system 1119 that includes application servers 1102, load balancing proxy servers 1103, data storage unit 1104, business logic computer 1122, and user interface module 1105 to perform electric vehicle related information processing functions. Employees of the EV information service provider company 1120 and other authorized personnel may use user interface module 1105 to access computer system 1119. User interface module 1105 may be any type of computing device that is configured to communicate with other computer systems. User interface module 1105 may be connected directly to application server 1102, or may access an application server 1102 via the load balancing proxy servers 1103. User interface module 1105 may connect to load balancing proxy servers 1103 via a local area network, a private data link, or via the internet. Although depicted as being part of EV information service provider company 1120 in FIG. 8, user interface module 1105 may be located remotely. The business logic computer 1122 is connected to the data storage unit 1104 and application servers 1102 over a local area network 1121, which may be part of communication system 1127. In addition, other network infrastructure, including, for example a firewall, backup servers, and back up data stores, may also be included in the system 1119, without departing from the scope of the invention. Communications over the local area network 1121 and/or over the Internet, in one implementation, may be encrypted. In addition, such communications, whether encrypted or not, may also be digitally signed for authenticating the source of the communications. The computer system 1119 may also include a certificate authority to authenticate one or more of the communications using public key infrastructure.

Based on data collected from the electric vehicles 900, charging stations 120, and/or any third party data sources 1107, an evaluation module may analyze and evaluate data associated with the electric vehicle 900. As used herein, a “module” may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

In one embodiment, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electric signals on a system or network. In addition, entire modules, or portions thereof, may also be implemented in programmable hardware devices such as field programmable gate arrays, programmable array logic, programmable logic devices or the like or as hardwired integrated circuits.

A business logic module, implemented preferably in business logic computer 1132, is used correlate and track charging information and/or perform risk analysis associated with the electric vehicle 900 based on the received data. The business logic module may use predictive models, such as neural networks, Bayesian networks, and support vector machines, in performing any underwriting and premium adjustments.

In one implementation, software operating on the application servers 1102 act merely as presentation and data extraction and conversion servers. All substantive business logic can be carried out on the business logic computer 1132. In this implementation, the application servers 1102 obtain data from the data storage unit 1104 and the business logic computer 1132 and incorporate that data into web pages (or other graphical user interface formats). These web pages are then communicated by the application servers 1102 through the load balancing proxy servers 1103 to user interface module 1105 for presentation. Upon receiving input from user interface module 1105, the application server 1102 translates the input into a form suitable for processing by the business logic computer 1132 and for storage by the data storage unit 1104. In this implementation, the application servers can be operated by third parties, who can add their own branding to the web pages or add other customized presentation data. In the alternative, at least some of the business logic is also carried out by the application servers 1102. Application servers 1102 may also include a webserver for automatically recovering or retrieving data from a local computer.

In another implementation, the application servers 1102 are software modules operating on one or more computers. One of the computers on which the application servers 1102 are operating may also serve as the business logic computer 1122 and/or as a load balancing proxy server 1103. In other implementations, the software operating on user interface module 1105 includes a thin or thick client application in addition to, or instead of web browser. The thin or thick client application interfaces with a corresponding server application operating on the application server 1102.

Thus, embodiments of the present invention may provide information to electric vehicle drivers and/or owners to reassure them regarding some of the aspects associated with the electric vehicle technology. Moreover, more accurate and current data about an electric vehicle may be transmitted to a driver or owner of the electric vehicle.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

Numerous modifications and variations of the present invention are possible in light of the above teachings. It is therefore to be understood that within the scope of the appended claims, the invention may be practiced otherwise than as specifically described herein.

1. A system for communication at an electric vehicle charging site, comprising:
an electric vehicle charging station for charging an electric vehicle;
a network operations center providing wired or wireless communication to at least the electric vehicle charging station;
a fiber hub located on the charging site and connecting a high-speed fiber-in line, from off-site, to at least one fiber-distribution line exiting the fiber hub; and
a small cell high speed wireless transceiver connected to the fiber hub through the at least one fiber-distribution line, the transceiver for transmitting and receiving wireless signals;
wherein
the network operations center is configured to send information to one or more persons in proximity to the transceiver including at least a driver of the electric vehicle and others inside or outside the electric vehicle,
the information from the network operations center comprising a menu of at least electric vehicle data and advertising data,
the electric charging station is connected to the fiber hub by the at least one fiber-distribution line exiting the fiber hub, and
the electric vehicle charging site provides for the one or more persons in proximity to the transceiver a combination of electric vehicle charging, high speed fiber internet communication, the electric vehicle data, and the advertising data.

2. The system of claim 1, wherein the network operations center is connected to the fiber hub through the at least one fiber-distribution line.

3. The system of claim 1, wherein the information from the network operations center is broadcast from the transceiver or is alternatively broadcast over a cell network.

4. The system of claim 1, wherein the advertising data comprises digital out-of-home advertising comprising digital media presented as digital billboards appearing on displays in a vicinity of the transceiver.

5. The system of claim 1, wherein the information from the network operations center comprises historical data including one or more past electric charge dates, past times, and amounts of electric charge for the electric vehicle.

6. The system of claim 1, wherein the menu comprises a menu of services displayed to the one or more persons in proximity to the transceiver.

7. The system of claim 6, wherein the menu of services comprises the electric vehicle data and digital out-of-home advertising data presented as digital billboards appearing on displays in a vicinity of the transceiver.

8. The system of claim 7, wherein the menu of services comprises the electric vehicle data, the digital out-of-home advertising data, and map data.

9. The system of claim 6, wherein the menu of services comprises entertainment data and educational data.

10. The system of claim 6, wherein the menu of services comprises information from the world-wide web.

11. The system of claim 6, wherein the menu of services comprises social media data.

12. The system of claim 1, wherein the network operations center is on site near the charging stations.

13. The system of claim 1, wherein the network operations center is off site and in internet communication with the fiber hub.

14. The system of claim 1, wherein the network operations center is in fiber communication with the hub and the transmitter.

15. The system of claim 1, wherein the charging stations are in fiber communication with the hub and the transmitter.

16. The system of claim 1, wherein the electric vehicle is in wireless communication with the transmitter and thereby in communication at least with the network operations center.

17. The system of claim 1, wherein a mobile device of the driver of the electric vehicle is in wireless communication with the transmitter and thereby in communication to the internet.

18. The system of claim 1, wherein the electric vehicle is in wireless communication with the transmitter and thereby in communication to the internet.

19. The system of claim 1, wherein a personal computing device of said others inside or outside the electric vehicle is in wireless communication with the transmitter and thereby in communication to the internet and thereby receives the advertising data.

20. The system of claim 1, wherein a mobile device of said others inside or outside the electric vehicle are in wireless communication with the transmitter and thereby in communication to the internet and thereby receives the advertising data.

21-28. (canceled)
